(19) United States
(12) Patent Application Publication
(10) Pub. No.: US 2022/0212608 A1
(43) Pub. Date: Jul. 7, 2022

(54) RETRACTABLE CUP HOLDER DEVICE MOUNT

(71) Applicant: Scosche Industries, Inc., Oxnard, CA (US)

(72) Inventor: Christopher Michael McSweyn, Oxnard, CA (US)

(21) Appl. No.: 17/142,653

(22) Filed: Jan. 6, 2021

(51) Int. Cl. B60R 11/02

(52) U.S. Cl. CPC B60R 11/0241; B60R 2011/0007

(57) ABSTRACT

A retractable cup holder device mount has a cup holder base defined by an open end and a base interior chamber. A base stalk platform is fitted over the open end of the cup holder base and has a platform clevis. A device mount neck has a neck clevis and a mounting head joint. An extension stalk is rotatably engaged to the platform clevis and to the device mount neck through a common longitudinal slot that is defined through the extension stalk. The extension stalk is selectively receivable within the base interior chamber of the cup holder base.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

### 1. Technical Field

The present disclosure relates generally to mounts to retain portable electronic devices, and more particularly to a retractable cup holder device mount.

### 2. Related Art

A wide variety of portable electronic devices are currently in existence on the market, though there has been a recent convergence towards a fewer category of devices that fulfill many needs. Typically, these are smartphones that which integrate functions and features that may have earlier been provided in separate, independent devices such as music players, gaming consoles, personal digital assistants, digital still and video cameras, electronic readers, mapping and navigation devices, and so on. Several short-to-medium range communications modalities are also integrated, including WiFi and Bluetooth for short-range/local data transfer links, as well as cellular communications systems that can substantially extend its communicative range.

When interacting with the smartphone for a brief moment, it may be held in the hand and placed back down following use. However, there may be some situations in which the user is performing a primary task not with or relating to the smartphone, e.g., operating a motor vehicle. Indeed, under most U.S. state distracted driving laws, the use of mobile devices while driving is prohibited. However, there is a need for viewing the display of the mobile device while operating the vehicle, such as for navigation purposes, or to answer incoming telephone calls via a headset or the vehicle sound system.

In response to these needs, various mounting devices have been developed. One configuration is a cradle that mechanically retains the smartphone, with the cradle being mounted to a structure. The compressive retention mechanisms are oftentimes cumbersome to engage and/or disengage, so more recently, magnetic mounts are being utilized. A mount head including one or more permanent magnets are fixed to the structure, with a metallic plate being attached to the rear of the smartphone. The magnets on the mount engage the metallic plate, thereby releasably engaging the smartphone to the mount.

Whether utilizing a mechanical/compressive retention or a magnetic retention, the mount is attached to a location within the interior of the vehicle that is visible and accessible by the driver and/or passengers. A variety of attachment modalities are known in the art, including suction cups and adhesives that secure the mount to a surface such as the windshield or the dashboard, adapters that fit within cupholders in the center console or within the compact disc player slot, as well as clips that attach to the louvers or grilles of air conditioning vents.

There are certain disadvantages associated with these mounting modalities. Suction cups rely upon a vacuum created between the open face of the cup and the mounting surface and requires a non-porous surface to establish and maintain the vacuum seal. Leather and textured vinyl/plastic surfaces typically found on the dashboard therefore do not remain in adequate engagement with the suction cup, so windshields and side windows are generally selected, notwithstanding the obstruction to the visual field of the driver. Moreover, temperature and pressure variations encountered in normal operating conditions weaken the hold of the suction cup, and the material of the suction cups tend to degrade over time and diminish the capacity to maintain the vacuum space. The use of adhesive sheets to couple to mount to the surface of the dashboard surface is also known, though extreme high and low temperatures can similarly degrade the adhesion strength of the material.

Vehicle interiors typically incorporate multiple cup holders. With an increasing amount of time being spent in automobiles due to longer commute times, farther destinations, and increased traffic, the need for enjoying refreshments while being otherwise idle expanded the demand for cup holders and other driver and passenger convenience features. A variety of cup holder designs are known in the art and include adjustment mechanisms to accommodate and securely retain a wide range of beverage container sizes. Although earlier cup holders were mere afterthoughts, in modern vehicles cup holders are integrated into the interior design. Common locations for cup holders include armrests, dashboards, and the center console—and in most cases, within immediate reach of the driver or passenger without obstructing essential vehicle controls. Accordingly, cup holders are suitable mount points for portable electronic devices, and mounting devices adapted therefor are known in the art.

Permanent or semi-permanent attachment of mounts to the vehicle interior structure is desirable to avoid the inconvenience of manipulating the mount hardware upon each use. However, to the extent the location of the mount is near an essential vehicle control (such as gear shifter, a hand brake, air conditioning dial/button, etc.) it may be necessary to remove the device and/or the mount entirely to access the control. Cup holder mounts, due to their proximity to the center console where such essential controls are typically located, are prone to this deficiency.

Accordingly, there is a need in the art for a device mount that can be attached to a cup holder within the vehicle interior but moved away to provide access to vehicle controls without removal of the mount or the electronic device. There is also a need in the art for a retractable cup holder device mount.

### BRIEF SUMMARY

The present disclosure contemplates various embodiments of a retractable cup holder device mount. In one embodiment, the device mount may include a cup holder base that is defined by an open end and a base interior chamber. The device mount may also include a base stalk platform with a platform clevis, and the base stalk platform may also be fitted over the open end of the cup holder base. There may be a device mount neck with a neck clevis and a mounting head joint. The device mount may additionally include an extension stalk that is rotatably engaged to the platform clevis and to the device mount neck through a common longitudinal slot that is defined through the extension stalk. The extension stalk may be selectively receivable within the base interior chamber of the cup holder base.

Another embodiment of the present disclosure contemplates a retractable cup holder device mount with a cupholder base. The cupholder base may include a platform clevis with a pair of opposing arms extending from a base platform. In turn, the base platform may define a passageway between the arms of the platform clevis. The mount may further include a device mount neck with a mounting head joint and a neck clevis. The neck clevis may include a pair of opposing arms extending from a neck body. There may additionally be an extension stalk that is in movable engagement with the platform clevis and to the device mount neck. The extension stalk may be receivable into the passageway of the cupholder base platform.

Yet another embodiment of the present disclosure may be a cup holder device mount that includes a cup holder base defining a base interior chamber with an open end and a closed end. The cup holder base may additionally define a substantially frustoconical side wall, which may include one or more apertures. The device mount may include a base stalk platform with a platform clevis, which is fitted over the open end of the cup holder base. There may also be a device mount neck including a neck clevis and a mounting head joint. The device mount may additionally incorporate an extension stalk that is rotatably engaged to the platform clevis and to the device mount neck through a slot defined through the extension stalk. The extension stalk may be selectively receivable within the base interior chamber of the cup holder base. The device mount may also include one or more cup holder engagement plugs extending through a corresponding one of the one or more apertures on the frustoconical side wall.

The present disclosure will be best understood accompanying by reference to the following detailed description when read in conjunction with the drawings.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a perspective view of one embodiment of a retractable cup holder device mount according to the present disclosure with a stalk shown in an extended position;

FIG. 2 is a perspective view of the retractable cup holder device mount with the stalk shown in a retracted position;

FIG. 3 is a detailed exploded perspective view of a stalk assembly of the retractable cup holder device mount;

FIG. 4 is a detailed exploded perspective view of a cup holder base assembly of the retractable cup holder device mount;

FIG. 5 is a cross-sectional view of the retractable cup holder device mount with the cup holder engagement members in a retracted position;

FIG. 6 is a cross-sectional view of the retractable cup holder device mount with the cup holder engagement members in an extended position;

### DETAILED DESCRIPTION

The detailed description set forth below in connection with the appended drawings is intended as a description of the several presently contemplated embodiments of a retractable cup holder device mount and is not intended to represent the only form in which such embodiments may be developed or utilized. The description sets forth the functions and features in connection with the illustrated embodiments. It is to be understood, however, that the same or equivalent functions may be accomplished by different embodiments that are also intended to be encompassed within the scope of the present disclosure. It is further understood that the use of relational terms such as first and second and the like are used solely to distinguish one from another entity without necessarily requiring or implying any actual such relationship or order between such entities.

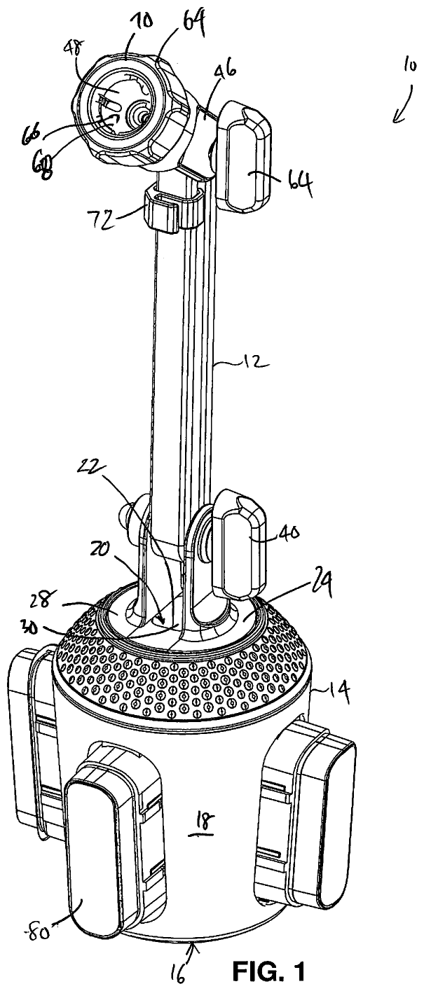

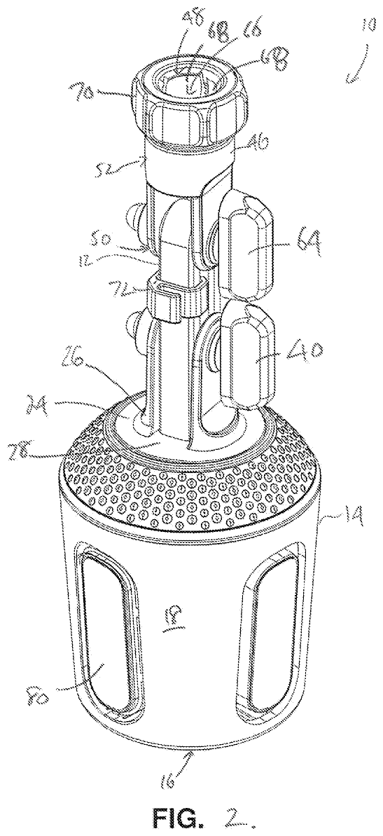

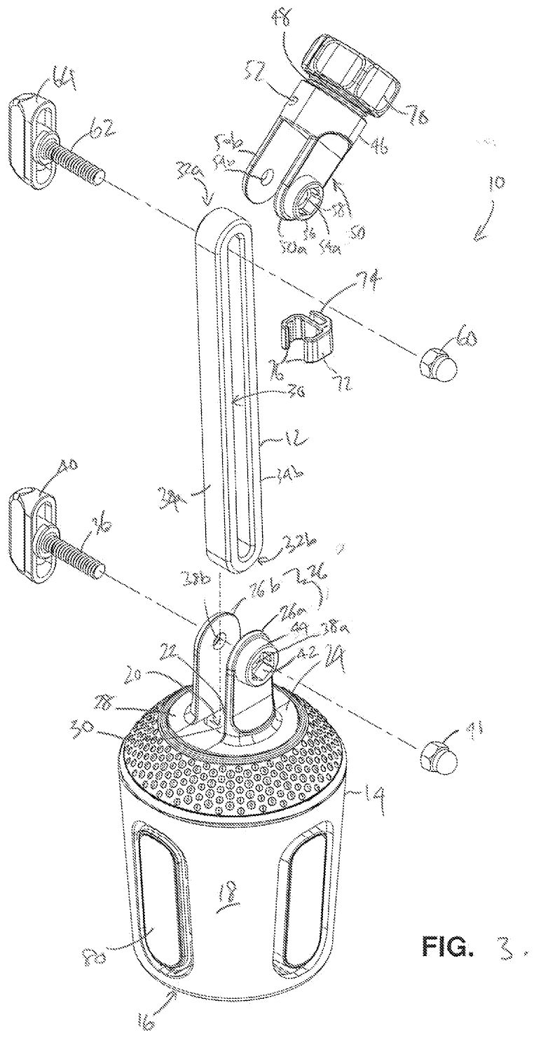

With reference to FIG. 1, FIG. 2 and FIG. 3, one embodiment of a retractable cup holder device mount 10, also referenced simply as a mount 10, incorporates an extension stalk 12 that can recede into a cup holder base 14. The mount 10, and specifically the cup holder base 14, is configured to be positioned within the recess of a cup holder. The mount 10 is contemplated for use in the interior of automobiles or other personal vehicles where an operator may desire to position a portable electronic device for ready accessibility, though this is by way of example only and not of limitation. Any other application where a cup holder is re-purposed for securing a device with the mount 10 may be substituted.

The cup holder base 14 is contemplated to be received within a cylindrical recess of typical cup holders, so it is correspondingly shaped. In this regard, the cup holder base 14 has a flat circular bottom 16 and a circumferential wall 18. In the embodiment shown, the circumferential wall 18 is tapered toward the flat circular bottom 16 in a frustoconical shape, though this is exemplary only and any other shape suitable for receptive engagement within a cup holder structure may be utilized without departing from the scope of the present disclosure. The cup holder base 14 generally defines an interior chamber 20, and opposite the flat circular bottom 16 is an open top end 22. Additional components make up the cup holder base 14, the details of which will be described more fully below.

The mount 10 further includes a base stalk platform 24 that is positioned or fitted over the open top end 22 of the cup holder base 14 and partially encloses the same. In further detail, the base stalk platform 24 has a platform clevis 26 with a first clevis arm 26a and a second clevis arm 26b that extend from a center region of a platform base 28. The part of the platform base 28 between the first clevis arm 26a and the second clevis arm 26b is open to the interior chamber 20, and is understood to be coextensive with the open top end 22 of the cup holder base 14.

The extension stalk 12 is envisioned to be in a sliding/receptive engagement with the platform clevis 26 and compressively retained between the first clevis arm 26a and the second clevis arm 26b. The extension stalk 12 has a unitary elongate structure that defines a common longitudinal slot 30 extending between opposed closed ends 32a and 32b. In this regard, the extension stalk 12 may also be described as having first and second longitudinal rails 34a, 34b with the common longitudinal slot 30 between the two structures. The rounded shape of the closed ends 32a, 32b are exemplary only, and any other shape may be substituted. The top and bottom ends of the common longitudinal slot 30 is understood to be circular to accommodate the clevis pins as will be detailed below. Because the extension stalk 12 is in sliding/receptive engagement with the platform clevis 26, the thickness of the longitudinal rails 34 may be less than, or at least substantially correspond to the distance between the first clevis arm 26a and the second clevis arm 26b. In order to minimize the flexing necessary to compressively retain the extension stalk 12 in position, however, the differential between the clevis arm spacing and the extension stalk 12 thickness is minimized.

The compressive force applied to the extension stalk 12 is further increased with a platform clevis pin 36 extending transversely though the common longitudinal slot 30 and across the first and second clevis arms 26a, 26b of the platform clevis 26. To accommodate the platform clevis pin 36, each of the first and second clevis arms 26a, 26b define respective first and second clevis pin holes 38a, 38b that are in axial alignment with each other. The platform clevis pin 36 is threaded, and a handle 40 is attached to an end thereof. Threaded on to the platform clevis pin 36 once inserted through the platform clevis 26 and the extension stalk 12 is a hex nut 41 received within a hexagonally shaped receptacle 42 that is defined within a boss 44 on the first clevis arm 26a. The receptacle 42 is understood to restrict rotational movement of the hex nut 41 while the platform clevis pin 36 is rotated by way of the handle 40, and so the tool-less loosening and tightening of the gripping force of the clevis arms 26 against the extension stalk 12 is possible.

With the platform clevis pin 36 inserted through the extension stalk 12, it may be considered to be in rotational engagement with the platform clevis 26. At the maximum extension of the extension stalk 12 relative to the platform clevis 26 as shown in FIG. 1, the rounded bottom end of the common longitudinal slot 30 abuts against the platform clevis pin 36 and is able to be rotated about the same. In addition to rotating about the pin axis, the extension stalk 12 may be slid through the opening of the platform base 28 and into the interior chamber 20. When the desired position of the extension stalk 12 relative to the platform clevis 26 is achieved, the platform clevis pin 36 may be tightened on to the hex nut 41 to prevent rotational and sliding movement of the extension stalk 12. As shown in FIG. 2, the extension stalk 12 may be retracted into the cup holder base 14, with the limit thereof being where the closed end 32b abuts against the bottom of the interior chamber 20.

The mount 10 also includes a device mount neck 46 that is generally defined by a mounting head joint 48, a neck clevis 50, and a center linking portion 52 between the mounting head joint 48 and the neck clevis 50. Like the platform clevis 26, the neck clevis 50 is comprised of a first clevis arm 50a and a second clevis arm 50b, each of which define respective clevis pin holes 54a, 54b that are in axial alignment with each other. The first clevis arm 50a further defines a boss 56 with a hexagonal receptacle 58 for another hex nut 60.

There is a neck clevis pin 62 that is threaded and includes a handle 64 for manual rotation. The neck clevis 50 is positioned on to the extension stalk 12 such that the common longitudinal slot 30 is in alignment with the clevis pin holes 54. The neck clevis pin 62 is inserted through the neck clevis 50 and the extension stalk 12, and is thus the device mount neck 46 is in rotating engagement with the extension stalk 12. That is, the neck clevis pin 62 extends transversely through the common longitudinal slot 30 and across the clevis arms 50a, 50b of the neck clevis 50. Like the platform clevis pin 36 discussed above, the neck clevis pin 62 is threaded on to the hex nut 60 and hand-tightened, thereby applying a compressive force to the clevis arms 50a, 50b against the extension stalk 12.

In one contemplated embodiment, the device mount neck does not include an opening at the center linking portion end of the neck clevis 50. As such, in order to slide the neck clevis 50 down the extension stalk 12, it may be necessary to rotate the neck clevis 50 away from an axial aligned position with respect to the common longitudinal slot 30. In the position of maximum extension, the neck clevis pin 62 abuts against the closed top end of the common longitudinal slot 30.

The mounting head joint 48 is configured to be engageable to a counterpart joint member that is fixed to a device mount head. It will be appreciated by those having ordinary skill in the art that any suitable device mount head may be utilized, including magnetic mount heads, mechanical/clamping heads, and combination charging/magnetic mount heads, among many others. As referenced herein, the device mount head is understood to be any modality by which a second object (e.g., a portable electronic device) is secured to the mount 10. The joint member that links the device mount head to the mounting head joint 48 may likewise be varied. In the illustrated embodiment, the mounting head joint 48 is a ball joint socket 66 comprised of multiple collets 68 that together define a spherical or partially spherical recess. A counterpart ball joint may be inserted into the ball joint socket 66, and be compressively retained therein by tightening a collet nut 70. Although a ball joint socket is illustrated, other embodiments may reverse the ball and the socket where the ball extends from the center linking portion 52 via a smaller, secondary stalk. Furthermore, while a ball joint modality has been described, it should be noted that any other suitable rotatable engagement modality may be substituted without departing from the scope of the present disclosure.

In some cases, the portable electronic device may be attached to the mount 10, and connected to a wired data and/or power connection. To better guide the cable to the device, the mount 10 may include a cable routing clip 72 that is in sliding engagement with the extension stalk 12, and specifically the longitudinal rails 34 thereof. The cable routing clip 72 may be defined by a hook portion 74 that receptively engages the cable, along with mount claws 76 that is sized and shaped for compressively engaging with the longitudinal rail 34. To this end, the cable routing clip 72 may be constructed of a rigid material with some degree of flex, such as plastic, to maintain compressive engagement with one of the longitudinal rails 34. Relatively free movement of the cable routing clip 72 would also be preferable, so materials with higher frictional coefficients may not be ideal in such embodiments.

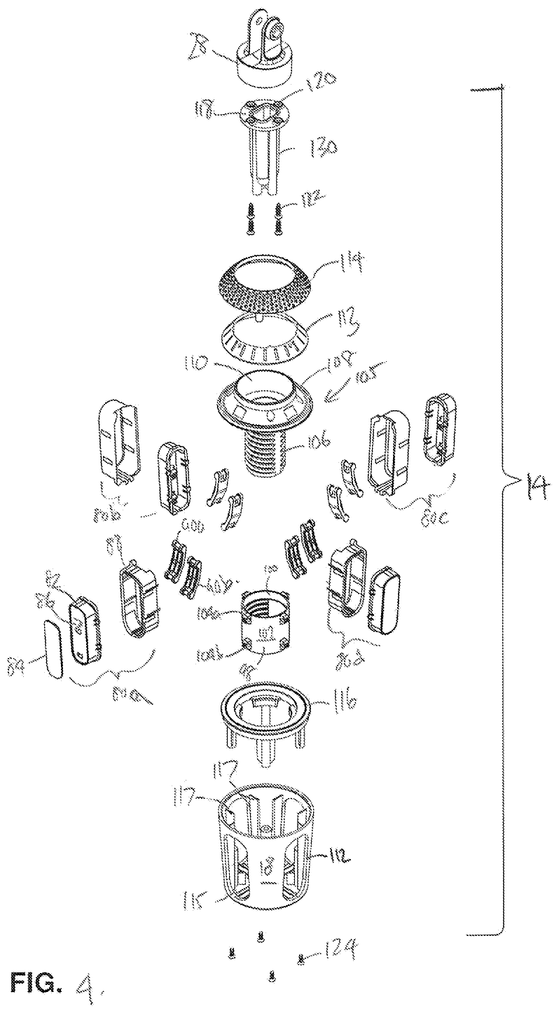

As indicated above, the cup holder base 14 may be comprised of additional components, though these are understood to be optional. The cup holder base 14 in the illustrated embodiment is understood to be adjustable, that is, the effective circumference can be expanded and narrowed depending on the specific size of the cup holder in which it is received. One possible embodiment utilizes a series of plugs 80 that are selectively extended and retracted from the interior of the cup holder base 14. Specifically, as shown in the exploded view of FIG. 4, there are four plug assemblies 80a, 80b, 80c, and 80d for each of the four general sectors of the circumferential wall 18. Each of the plug assemblies 80 includes a corresponding inner plug 82 with an elastomeric pad 84 attached to an outer face 86 thereof. Additionally, each plug assembly 80 includes an outer shell 88 within which the inner plug 82 is nested, with the inner plug 82 being in a sliding relation to the outer shell 88. As will be described in further detail below, a desirable effective circumference may be set depending on the extension distance of the inner plug 82 and/or the outer shell 88 from the circumferential wall 18.

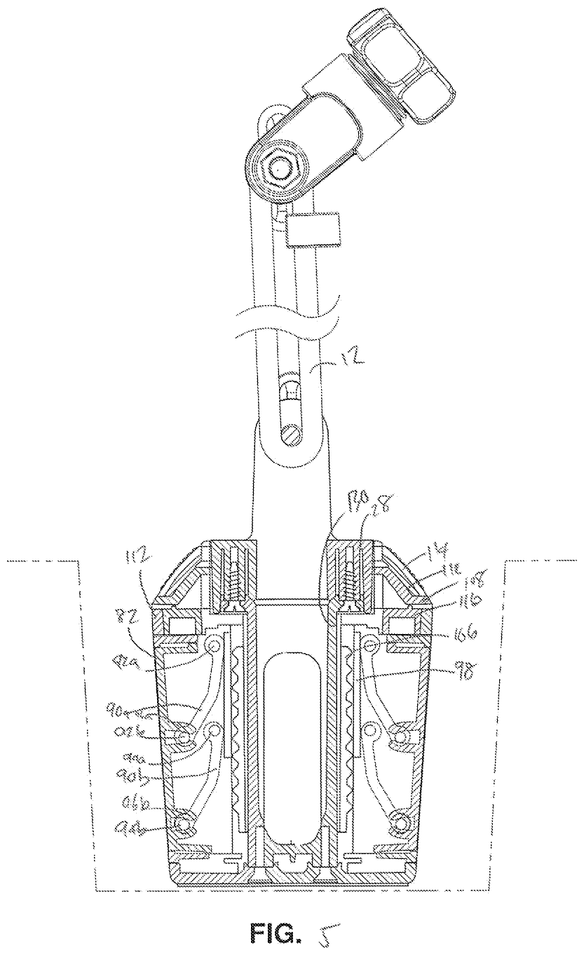

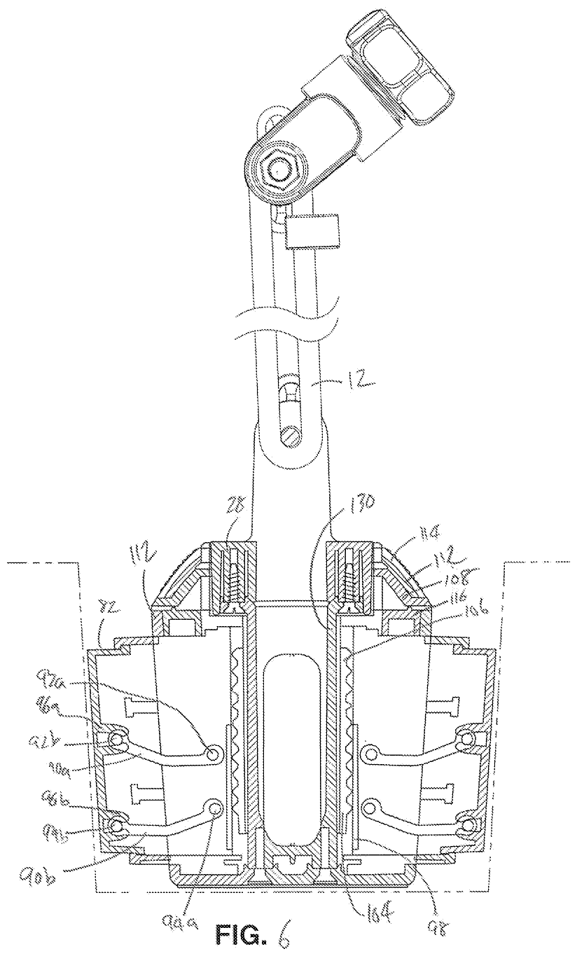

Such lateral extension of the plug assembly 80 (relative to the longitudinal axis of the cup holder base 14) may be achieved with a pair of dual pivoting arms 90 including an upper dual pivoting arm 90a and a lower dual pivoting arm 90b. In some embodiments, these may also be referred to as an extension arm With additional reference to the cross-sectional views of FIG. 5 and FIG. 6, the upper dual pivoting arm 90a includes an inner pivot pin 92a and an outer pivot pin 92b, and the lower dual pivoting arm 90b likewise includes an inner pivot pin 94a and an outer pivot pin 94b. The interior side of the inner plug 82 defines an upper bearing 96a and a lower bearing 96b that are in pivoting engagement with the upper and lower dual pivoting arms 90a, 90b, respectively. In further detail, the outer pivot pin 92b of the upper dual pivoting arm 90a is rotatably coupled to the upper bearing 96a, and the outer pivot pin 94b of the lower dual pivoting arm 90b is rotatably coupled to the lower bearing 96b.

The upper and lower dual pivoting arms 90 are each mounted to a shuttle 98 that includes corresponding bearings therefor. The shuttle 98 is understood to have a hollow cylindrical structure with an inner threaded wall 100 and an outer wall 102. On the outer wall 102, there is an upper bearing 104a and a lower bearing 104b corresponding to each pair of the dual pivoting arms 90. The inner pivot pin 92a of the upper dual pivoting arm 90a is rotatably coupled to the upper bearing 104a, while the inner pivot pin 94a of the lower dual pivoting arm 90b is rotatably coupled to the lower bearing 104b. The vertical up-and-down movement of the shuttle 98 is understood to be translated into the lateral extension of the plug assemblies 80, with FIG. 5 showing the minimal extension of the dual pivoting arms 90 resulting from the shuttle 98 being raised to its maximum limit, and FIG. 6 showing the maximum extension of the dual pivoting arms 90 resulting from the shuttle 98 being lowered to its minimum limit.

The vertical, up-and-down movement of the shuttle 98 is made possible with a rotor 105 to which the inner threaded wall 100 is coupled. More particularly, the rotor 105 includes a hollow threaded shaft 106 and a circular or frustoconical knob head 108. To provide an opening into the interior of the hollow threaded shaft 106, the knob head 108 also defines an opening 110. As the knob head 108, and hence the shaft 106 is rotated, the shuttle 98 is understood to move up and down the threading of the shaft 106.

The foregoing assembly of the rotor 105, shuttle 98, the upper and lower dual pivoting arms 90, and the plug assemblies 80 are disposed within a mount receptacle 112 that defines the aforementioned wall 18. The mount receptacle 112, and hence the circumferential wall 18, defines a series of apertures 115 that are generally aligned with the positioning of the plug assemblies 80. Furthermore, each of the apertures 115 may further be bounded by a pair of opposed interior guide walls 117 that maintain the outer shell 88 in alignment with the lateral movement axis thereof.

The cup holder base 14 may further including a guide frame 116 fitted over the opening of the mount receptacle 112. The guide frame 116 is defined by an circular bearing frame that is in freely rotating engagement with the knob head 108. Attached to the knob head 108 may be a knob coupling 113, as well as a knob decorative piece 114. The knob decorative piece 114 may have a tactile surface by which the user can rotate the rotor 105.

As indicated above, various embodiments of the present disclosure contemplate the extension stalk 12 being recessed within the interior of the cup holder base 14. In this regard, there is also a stalk receptacle 130 that is inserted into the hollow portion of the rotor 105/shaft 106. The stalk receptacle 130 defines a flanged face 118 with a set of spaced fastener holes 120, which may be aligned with corresponding fastener channels defined on the platform base 28 for attachment thereto with fasteners 122. Along these lines, the stalk receptacle 130 may also be attached to the mount receptacle 112 with fasteners 124. The hollow interior of the stalk receptacle 130 is understood to correspond to/equivalent to the aforementioned interior chamber 20 of the cup holder base 14.

The particulars shown herein are by way of example and for purposes of illustrative discussion of the embodiments of the retractable cup holder device mount and are presented in the cause of providing what is believed to be the most useful and readily understood description of the principles and conceptual aspects. In this regard, no attempt is made to show details with more particularity than is necessary, the description taken with the drawings making apparent to those skilled in the art how the several forms of the present disclosure may be embodied in practice.

What is claimed is:

1. A retractable cup holder device mount, comprising:
a cup holder base defined by an open end and a base interior chamber;
a base stalk platform including a platform clevis and fitted over the open end of the cup holder base;
a device mount neck including a neck clevis and a mounting head joint; and
an extension stalk rotatably engaged to the platform clevis and to the device mount neck through a common longitudinal slot defined through the extension stalk, the extension stalk being selectively receivable within the base interior chamber of the cup holder base.

2. The retractable cup holder device mount of claim 1, further comprising:
a platform clevis pin extending transversely through the common longitudinal slot and across arms of the platform clevis.

3. The retractable cup holder device mount of claim 2, wherein the platform clevis pin is threadably engaged to a corresponding platform clevis nut.

4. The retractable cup holder device mount of claim 1, further comprising:
a neck clevis pin extending transversely through the common longitudinal slot and across arms of the neck clevis.

5. The retractable cup holder device mount of claim 4, wherein the neck clevis pin is threadably engaged to a corresponding neck clevis nut.

6. The retractable cup holder device mount of claim 1 wherein the extension stalk is defined by longitudinal rails separated by the common longitudinal slot.

7. The retractable cup holder device mount of claim 6, further comprising:
a cable routing clip defined by a hook portion and a mount claw in sliding engagement with the longitudinal rails.

8. The retractable cup holder device mount of claim 1, wherein the mounting head joint is a ball socket.

9. The retractable cup holder device mount of claim 1, wherein the mounting head joint is a ball.

10. A retractable cup holder device mount, comprising:
a cupholder base with a platform clevis including a pair of opposing arms extending from a base platform defining a passageway between the arms of the platform clevis;
a device mount neck with a mounting head joint and a neck clevis including a pair of opposing arms extending from a neck body; and
an extension stalk in movable engagement with the platform clevis and to the device mount neck, the extension stalk being receivable into the passageway of the cupholder base platform.

11. The retractable cup holder device mount of claim 10, further comprising:
a neck clevis pin extending transversely through the extension stalk and the pair of opposing arms of the neck clevis; and
a platform clevis pin extending transversely through the extension stalk and the pair of opposing arms of the platform clevis.

12. The retractable cup holder device mount of claim 11 further comprising:
pin nuts threadable onto respective ones of the neck clevis pin and the platform clevis pin compressively retaining the base platform and the device mount neck to the extension stalk.

13. The retractable cup holder device mount of claim 11, wherein the extension stalk defines a contiguous longitudinal slot through which the neck clevis pin and the platform clevis pin extend.

14. The retractable cup holder device mount of claim 10 wherein the mounting head joint is a ball socket.

15. The retractable cup holder device mount of claim 10, wherein the mounting head joint is a ball.

16. A cup holder device mount, comprising:
a cup holder base defining a base interior chamber with an open end and a closed end, and a substantially frustoconical side wall, one or more apertures defined by the frustoconical side wall;
a base stalk platform including a platform clevis and fitted over the open end of the cup holder base;
a device mount neck including a neck clevis and a mounting head joint;
an extension stalk rotatably engaged to the platform clevis and to the device mount neck through a slot defined through the extension stalk, the extension stalk being selectively receivable within the base interior chamber of the cup holder base; and
one or more cup holder engagement plugs extending through a corresponding one of the one or more apertures on the frustoconical side wall.

17. The cup holder device mount of claim 16, further comprising:
a neck clevis pin extending transversely through the extension stalk and the neck clevis; and
a platform clevis pin extending transversely through the extension stalk and the platform clevis.

18. The cup holder device mount of claim 16, further comprising:
a rotor including a threaded shaft and an external knob;
a shuttle in engagement with the threaded shaft; and
one or more extension arms pivotally mounted to the shuttle and to a corresponding one of the one or more cup holder engagement plugs;
wherein rotational movement of the rotor is translated to axial movement of the shuttle along a longitudinal axis of the threaded shaft and a corresponding lateral movement of the extension arms and the cup holder engagement plugs along an axis transverse thereto.

19. The cup holder device mount of claim 18, further comprising:
a guide frame in retentive engagement with the rotor, the shuttle, and the cup holder base.

20. The cup holder device mount of claim 18, wherein the cup holder engagement plugs each include an inner plug nested within a shell and being in sliding engagement therewith, a given one of the extension arms being pivotally mounted to the inner plug.
